(19) United States
(12) Patent Application Publication
(10) Pub. No.: US 2019/0324175 A1
(43) Pub. Date: Oct. 24, 2019

(54) METHODS FOR ENHANCING THE DURABILITY AND MANUFACTURABILITY OF MULTILAYER INTERFERENCE MIRRORS

(71) Applicant: Honeywell International Inc., Morris Plains, NJ (US)

(72) Inventors: Steve C. Albers, Coon Rapids, MN (US); Dean E. Johnson, Orono, MN (US); Randy Ramberg, Roseville, MN (US); Lance Vrieze, Oakdale, MN (US)

(73) Assignee: Honeywell International Inc., Morris Plains, NJ (US)

(21) Appl. No.: 15/956,672

(22) Filed: Apr. 18, 2018

(51) Int. Cl. G02B 5/08; G02B 5/28; H01S 3/083; H01S 3/08; G01C 19/66

(52) U.S. Cl. CPC G02B 5/0858; G02B 5/285; G01C 19/661; H01S 3/08059; H01S 3/083

(57) ABSTRACT

A multilayer mirror, method, and ring layer gyroscope (RLG) are disclosed. For example, the method includes forming a plurality of layers of a first index of refraction optical material on a substrate, forming a plurality of layers of a second index of refraction optical material between the layers of the first index of refraction optical material, forming a layer of a durable optical material on an outermost layer of the plurality of layers of the first index of refraction optical material, and forming an over-coating of a protective material on a surface of the layer of the durable optical material.

### BACKGROUND

Multilayer interference mirrors utilized as laser mirrors in Ring Laser Gyroscopes (RLGs) are continually exposed to high energy plasma operating environments that degrade the mirrors by reducing oxide in the refraction materials and thereby inducing photochromic losses. These mirrors are typically formed as stacks of alternating (e.g., ¼λ, thickness) layers of relatively high and relatively low index of refraction materials.

In order to reduce the degrading effects of the high energy plasma operating environments, the high index of refraction materials are typically formed with metal oxides having a relatively high bonding energy to oxygen (e.g., Zirconium Oxide or ZrO₂). For example, ZrO₂ is often utilized as the top layer of the stacks in interference mirrors, because ZrO₂ exhibited a relatively high resistance to degradation in high energy plasma environments. Additionally, ZrO₂ is compatible with the relatively high temperatures to which the mirrors are exposed during the manufacturing processes of the RLGs involved. However, a problem with utilizing ZrO₂ as the top layer of the stack in an interference mirror is that ZrO₂ tends to form a micro-crystalline structure when deposited. These micro-crystalline structures may create scattering sites that can increase the photochromic losses in the interference mirrors involved and also reduce their operational lives.

Aluminum Oxide (AiO₃) is another material that is often utilized as the top layer of the stack in interference mirrors, because AiO₃ also has a relatively large heat of formation and exhibits a relatively high resistance to degradation in plasma environments. Also, the AiO₃ materials utilized exhibit superior ultra-violet (UV) energy blocking characteristics that function to protect the integrity of the underlying layers in the stacks of the interference mirrors involved. However, a significant manufacturing problem with utilizing AiO₃ as the outer/top layer in an interference mirror is that the AiO₃ material is etched relatively easily by the chemical cleaning and storage solutions commonly utilized during the manufacturing process, which degrades the outer surface of the interference mirror involved. Therefore, the need exists for a technique that can be utilized to protect the AiO₃ outer/top layer of the interference mirror during the manufacturing process, and thereby eliminate the surface degradation of the outer/top layer caused by the chemical cleaning and storage solutions utilized.

For the reasons stated above and for other reasons stated below which will become apparent to those skilled in the art upon reading and understanding the specification, there is a need in the art for methods for enhancing the manufacture of multilayer interference mirrors utilized, for example, in RLG devices.

### SUMMARY

Embodiments disclosed herein present techniques for enhancing the durability and manufacturability of multilayer interference mirrors utilized as laser mirrors in RLG devices.

### DRAWINGS

Embodiments of the present disclosure can be more easily understood and further advantages and uses thereof more readily apparent, when considered in view of the description of the preferred embodiments and the following figures in which:

FIG. 1 is a simplified structural diagram illustrating a multilayer mirror that can be utilized to implement one example embodiment of the present invention.

FIG. 2 is a simplified block diagram illustrating a ring laser gyroscope (RLG) that can be utilized to implement the multilayer mirror depicted in the exemplary embodiment illustrated in FIG. 1.

FIG. 3 is a flow diagram illustrating a method that can be utilized to implement one example embodiment of the present invention.

In accordance with common practice, the various described features are not drawn to scale but are drawn to emphasize features relevant to the present disclosure. Reference characters denote like elements throughout the figures and text.

### DETAILED DESCRIPTION

In the following detailed description, reference is made to the accompanying drawings that form a part hereof, and in which is shown by way of specific illustrative embodiments in which the embodiments may be practiced. These embodiments are described in sufficient detail to enable those skilled in the art to practice the embodiments, and it is to be understood that other embodiments may be utilized and that logical, mechanical and electrical changes may be made without departing from the scope of the present disclosure. The following detailed description is, therefore, not to be taken in a limiting sense.

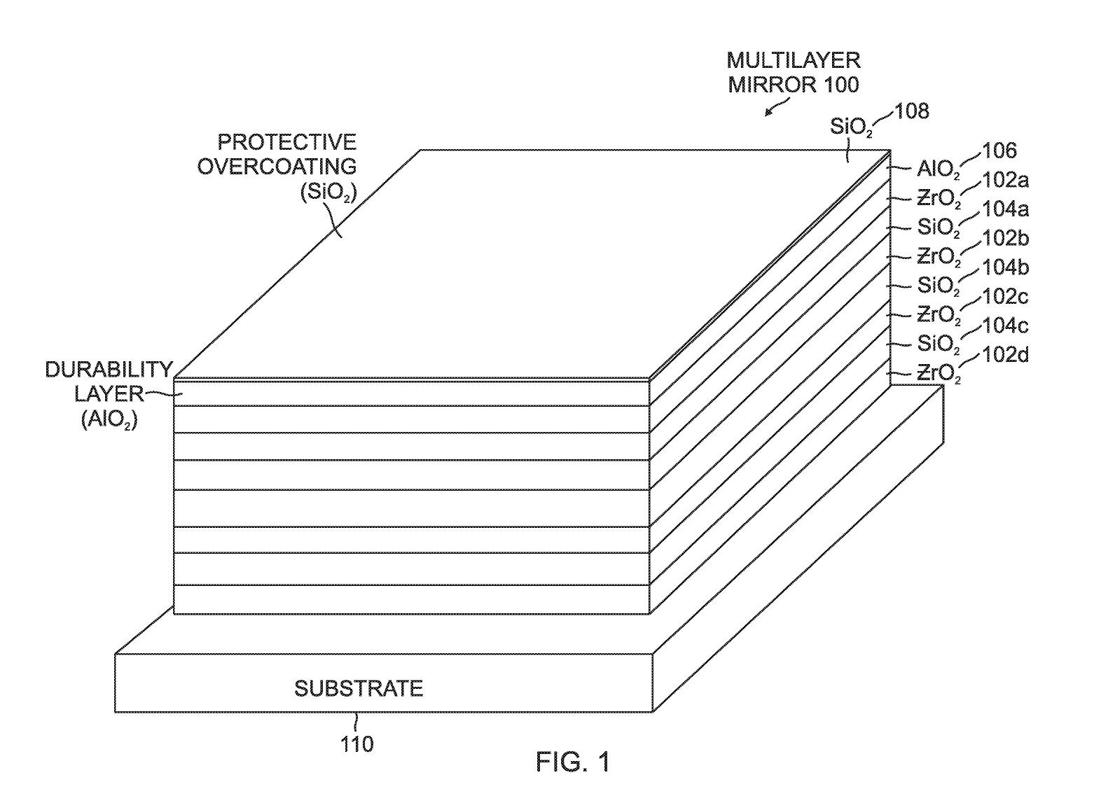

FIG. 1 is a simplified structural diagram illustrating an enhanced multilayer mirror 100, which can be utilized to implement one example embodiment of the present invention. For example, in one embodiment, the multilayer mirror 100 is an interference mirror for a ring laser gyroscope (RLG). In a second embodiment, the multilayer mirror 100 is a reflective mirror stack including an outer layer configured to provide enhanced operational durability, and an overcoat on the outer layer configured to inhibit degradation caused by existing manufacturing finishing techniques. Referring to the example embodiment illustrated in FIG. 1, the multilayer mirror 100 includes a plurality of alternating (e.g., interleaved) ZrO₂ layers 102a-102d and SiO₂ layers 104a-104c. For example, in one embodiment, the ZrO₂ layers 102a-102d and SiO₂ layers 104a-104c are optical quarter-wave (e.g., nominally or substantially quarter-wave) structures that are formed utilizing a suitable deposition process (e.g., electron beam or ion beam deposition process). Notably, although a finite number of ZrO₂ and SiO₂ layers are shown for this exemplary embodiment, this particular number of layers is merely for illustrative purposes and several more alternating ZrO₂ and SiO₂ layers may be deposited in the multilayer mirror 100.

For this example embodiment, the enhanced multilayer mirror 100 also includes an outermost layer (e.g., durability layer) 106 deposited on the ZrO₂ layer 102a. In this example embodiment, the outermost layer 106 is a metal oxide material having a relatively high heat of formation (e.g., Aluminum Oxide or AiO₂/Al₂O₃). As such, for this embodiment, the AiO₂/Al₂O₃ material is selected for the outermost layer 106 primarily because the AiO₂/Al₂O₃ material has superior UV energy blocking characteristics and can thereby protect the underlying ZrO₂ and SiO₂ layers in that regard. However, on the other hand, the AiO₂/Al₂O₃ material has manufacturing challenges because it can be etched and its surface degraded (e.g., referred to as etching degradation) by the cleaning and storage solutions utilized during the fabrication finishing process. Consequently, in order to mitigate these manufacturing process problems, an overcoat 108 of a process-friendly (e.g., SiO₂) material, which is impervious to the etching degradation caused by the cleaning and storage finishing solutions, is applied to the outer surface of the outermost layer 106. For example, a thin coating of (e.g., 10 angstroms in thickness) of a SiO₂ material can be applied (e.g., utilizing a suitable deposition process) as an overcoat to the outermost (e.g., durability) layer 106. In this embodiment, the multilayer mirror 100 including the stack of substantially quarter-wavelength layers and the process-friendly overcoat 108 is formed (e.g., by a suitable deposition process) on a substrate 110.

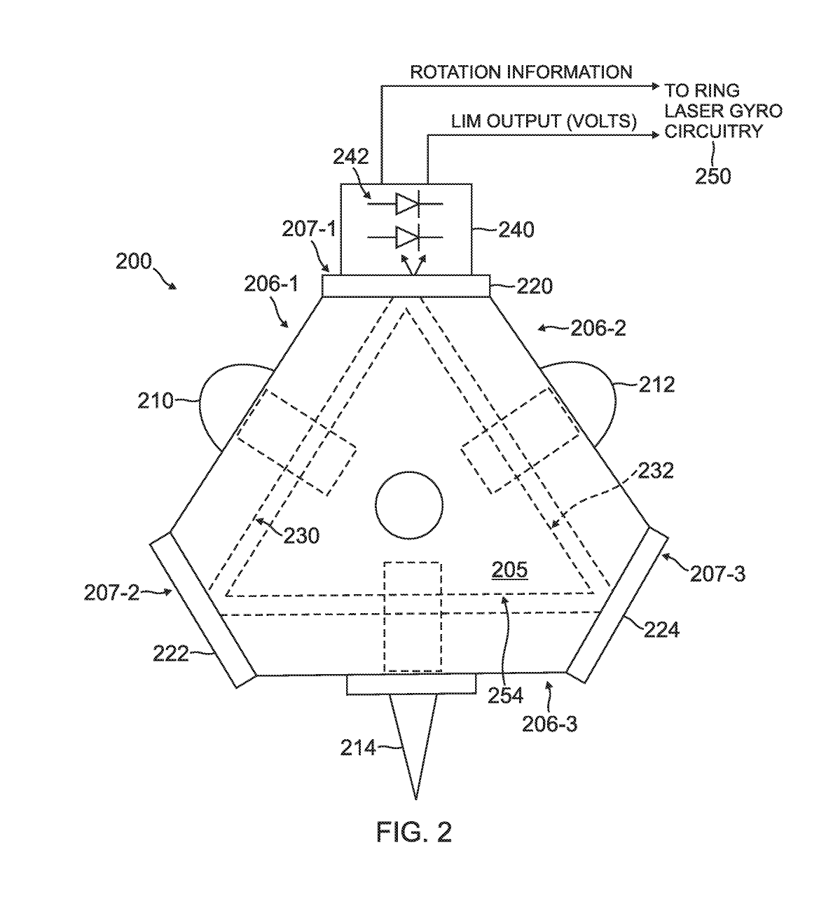

FIG. 2 is a simplified block diagram illustrating a ring laser gyroscope (RLG) 200, which can be utilized to implement one exemplary embodiment of the present invention. Referring to the example embodiment depicted in FIG. 2, the RLG 200 includes a laser block assembly 205, which in this embodiment, is triangular-shaped with three sides 206-1, 206-2 and 206-3. The laser block assembly 205 has three corners 207-1, 207-2 and 207-3. A first cathode 210 is disposed on side 206-1 of the laser block assembly 205, a second cathode 212 is disposed on side 206-2, and an anode 214 is disposed on side 206-3. The RLG 200 further includes multilayer mirrors 220, 222 and 224, which are disposed at the respective corners 207-1, 207-2 and 207-3 of the laser block assembly 205. A cavity 230, 232 and 234 is disposed within the laser block assembly 205 and parallel to the respective sides 206-1, 206-2 and 206-3. The cavity 230, 232, 234 is configured in conjunction with the multilayer mirrors 220, 222 and 224 to form a ring shaped laser beam path around the laser block assembly 205. The cavity 230 is filed with a suitable gas mixture of Helium and Neon. In one exemplary embodiment, the RLG 200 can include a readout assembly 240 with two photo diodes 242, which in operation, couples optical energy information from the cavity 230, 232, 234 and converts the optical energy to voltage signals from which rotation information can be obtained. The readout assembly 240 also outputs a voltage signal correlated with a laser intensity signal referred to as the Laser Intensity Monitor (LIM) signal. The LIM signal voltage provides information associated with the optical energy within the cavity 230. The output rotation information and LIM voltage are coupled to RLG circuitry 250, which processes the rotation information to facilitate the (e.g., inertial) navigation of a vehicle involved. Notably, in accordance with the teachings of the present disclosure, the multilayer mirrors 220, 222 and 224 are implemented in accordance with the multilayer mirror 100 described above with respect to the exemplary embodiment illustrated in FIG. 1.

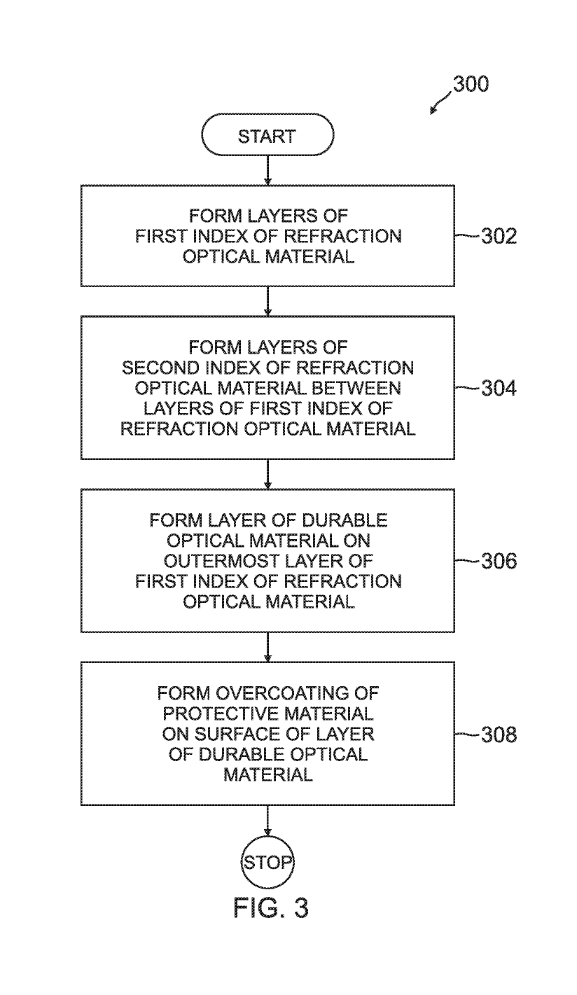

FIG. 3 is a flow diagram illustrating a method 300, which can be utilized to implement one example embodiment of the present invention. Referring to the example embodiments illustrated in FIGS. 1 and 3, the exemplary method begins by forming a first plurality of layers 102a-102d of a high index of refraction optical material, such as, for example, ZrO₂ (302), and also forming a second plurality of layers 104a-104c of a low index of refraction optical material, such as, for example, SiO₂, between the layers 102a-102d (304). More precisely, as illustrated in FIG. 1, a first layer 102d of ZrO₂ is deposited (e.g., utilizing an electron beam or ion beam deposition process) on a substrate 110. A first layer 104c of SiO₂ is then deposited (e.g., also utilizing an electron beam or ion beam deposition process) on the exposed surface of the first layer 102d of ZrO₂. Next, a second layer 102c of ZrO₂ is deposited on the exposed surface of the first layer 104c of SiO₂, and then a second layer 104b of SiO₂ is deposited on the exposed surface of the second layer 102c of ZrO₂. Next, a third layer 102b of ZrO₂ is deposited on the exposed surface of the second layer 104b of SiO₂, and then a third layer 104a of SiO₂ is deposited on the exposed surface of the third layer 102b of ZrO₂. A fourth layer 102a of ZrO₂ is then deposited on the third layer 104a of SiO₂. Notably, although the exemplary embodiment illustrated in FIG. 1 depicts four layers 102a-102d of ZrO₂ and three layers 104a-104c of SiO₂, the present disclosure is not intended to impose an upper or lower limit to the number of layers that can be utilized in other embodiments. Also, although the exemplary embodiment illustrated in FIG. 1 depicts layers of ZrO₂ and SiO₂ for the layers 102a-102d and 104a-104c, the present disclosure is not intended to limit the high index of refraction and low index of refraction optical materials only to layers of ZrO₂ and SiO₂ that can be utilized in other embodiments.

Returning to the method 300, a layer 106 of a durable optical material (e.g., AiO₂ in this embodiment) is deposited (e.g., utilizing an electron beam or ion beam deposition process) on the exposed surface of the outermost layer 102a of the high index of refraction optical material ZrO₂ (306). This “durability layer” 106 has enhanced UV energy blocking characteristics and also provides physical protection for the underlying layers of ZrO₂ and SiO₂. An over-coating 108 of an additional protective material (e.g., SiO₂) is then deposited (e.g., utilizing an electron beam or ion beam deposition process) on the exposed surface of the durability layer 106 (308). As such, this protective over-coating 108 protects the underlying layer 106 because the material utilized (e.g., SiO2) is impervious to the etching degradation that can occur to the durability layer 106 due to the cleaning and storage solutions utilized during the final fabrication process.

It should be understood that elements of the above described embodiments and illustrative figures may be used in various combinations with each other to produce still further embodiments which are explicitly intended as within the scope of the present disclosure.

### Example Embodiments

Example 1 includes a multilayer mirror, comprising: a plurality of alternating layers of a high index of refraction optical material and a low index of refraction optical material; a durability layer of an optical material disposed on the plurality of alternating layers; and an overcoat of a protective material on an outermost surface of the durability layer.

Example 2 includes the multilayer mirror of Example 1, wherein the high index of refraction material comprises a Zirconium Oxide (ZrO₂) layer of material.

Example 3 includes the multilayer mirror of any of Examples 1-2, wherein the low index of refraction material comprises a Silicon Oxide (SiO₂) layer of material.

Example 4 includes the multilayer mirror of any of Examples 1-3, wherein the durability layer comprises an Aluminum Oxide (AiO₂) layer of material.

Example 5 includes the multilayer mirror of any of Examples 1-4, wherein the overcoat of the protective material comprises a coating of a SiO₂ material.

Example 6 includes the multilayer mirror of any of Examples 1-5, wherein the plurality of alternating layers comprise a plurality of substantially quarter wavelength structures.

Example 7 includes the multilayer mirror of any of Examples 1-6, further comprising a substrate material under the plurality of alternating layers.

Example 8 includes the multilayer mirror of any of Examples 5-7, wherein the coating of the SiO₂ material is substantially thinner than the thickness of each layer of the plurality of layers.

Example 9 includes the multilayer mirror of any of Examples 1-8, wherein the multilayer mirror comprises a reflective mirror for a laser cavity in a ring laser gyroscope (RLG).

Example 10 includes the multilayer mirror of any of Examples 1-9, wherein the overcoat is impervious to etching degradation.

Example 11 includes a ring laser gyroscope, comprising: a laser block assembly; a cavity in the laser block assembly; and a plurality of multilayer mirrors in the cavity, wherein at least one multilayer mirror of the plurality of multilayer mirrors comprises: a plurality of alternating layers of a high index of refraction optical material and a low index of refraction optical material; a durability layer of an optical material disposed on the plurality of alternating layers; and an overcoat of a protective material on an outermost surface of the durability layer.

Example 12 includes the ring laser gyroscope of Example 11, wherein the durability layer comprises an Aluminum Oxide layer of material.

Example 13 includes the ring laser gyroscope of any of Examples 11-12, wherein the overcoat of the protective material comprises a coating of a SiO₂ material.

Example 14 includes the ring laser gyroscope of any of Examples 11-13, wherein the plurality of multilayer mirrors comprises three or more multilayer reflective mirrors.

Example 15 includes the ring laser gyroscope of any of Examples 11-14, wherein the high index of refraction optical material comprises Zirconium Oxide and the low index of refraction optical material comprises Silicon Oxide.

Example 16 includes a method, comprising: forming a plurality of layers of a first index of refraction optical material on a substrate; forming a plurality of layers of a second index of refraction optical material between the layers of the first index of refraction optical material; forming a layer of a durable optical material on an outermost layer of the plurality of layers of the first index of refraction optical material; and forming an over-coating of a protective material on a surface of the layer of the durable optical material.

Example 17 includes the method of Example 16, wherein the forming the plurality of layers of the first index of refraction optical material comprises forming layers of Zirconium Oxide.

Example 18 includes the method of any of Examples 16-17, wherein the forming the plurality of layers of the second index of refraction optical material comprises forming layers of Silicon Oxide.

Example 19 includes the method of any of Examples 16-18, wherein the forming the layer of the durable optical material comprises forming a layer of Aluminum Oxide.

Example 20 includes the method of any of Examples 16-19, wherein the forming the over-coating comprises forming a coating of Silicon Oxide.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the presented embodiments. Therefore, it is manifestly intended that embodiments be limited only by the claims and the equivalents thereof.

What is claimed is:

1. A multilayer mirror, comprising:
a plurality of alternating layers of a high index of refraction optical material and a low index of refraction optical material;
a durability layer of an optical material disposed on the plurality of alternating layers; and
an overcoat of a protective material on an outermost surface of the durability layer.

2. The multilayer mirror of claim 1, wherein the high index of refraction material comprises a Zirconium Oxide (ZrO₂) layer of material.

3. The multilayer mirror of claim 1, wherein the low index of refraction material comprises a Silicon Oxide (SiO₂) layer of material.

4. The multilayer mirror of claim 1, wherein the durability layer comprises an Aluminum Oxide (AiO₂) layer of material.

5. The multilayer mirror of claim 1, wherein the overcoat of the protective material comprises a coating of a SiO₂ material.

6. The multilayer mirror of claim 1, wherein the plurality of alternating layers comprise a plurality of substantially quarter wavelength structures.

7. The multilayer mirror of claim 1, further comprising a substrate material under the plurality of alternating layers.

8. The multilayer mirror of claim 5, wherein the coating of the SiO2 material is substantially thinner than the thickness of each layer of the plurality of layers.

9. The multilayer mirror of claim 1, wherein the multilayer mirror comprises a reflective mirror for a laser cavity in a ring laser gyroscope (RLG).

10. The multilayer mirror of claim 1, wherein the overcoat is impervious to etching degradation.

11. A ring laser gyroscope, comprising:
a laser block assembly;
a cavity in the laser block assembly; and
a plurality of multilayer mirrors in the cavity, wherein at least one multilayer mirror of the plurality of multilayer mirrors comprises:
a plurality of alternating layers of a high index of refraction optical material and a low index of refraction optical material;
a durability layer of an optical material disposed on the plurality of alternating layers; and
an overcoat of a protective material on an outermost surface of the durability layer.

12. The ring laser gyroscope of claim 11, wherein the durability layer comprises an Aluminum Oxide layer of material.

13. The ring laser gyroscope of claim 11, wherein the overcoat of the protective material comprises a coating of a SiO₂ material.

14. The ring laser gyroscope of claim 11, wherein the plurality of multilayer mirrors comprises three or more multilayer reflective mirrors.

15. The ring laser gyroscope of claim 11, wherein the high index of refraction optical material comprises Zirconium Oxide and the low index of refraction optical material comprises Silicon Oxide.

16. A method, comprising:
forming a plurality of layers of a first index of refraction optical material on a substrate;
forming a plurality of layers of a second index of refraction optical material between the layers of the first index of refraction optical material;
forming a layer of a durable optical material on an outermost layer of the plurality of layers of the first index of refraction optical material; and
forming an over-coating of a protective material on a surface of the layer of the durable optical material.

17. The method of claim 16, wherein the forming the plurality of layers of the first index of refraction optical material comprises forming layers of Zirconium Oxide.

18. The method of claim 16, wherein the forming the plurality of layers of the second index of refraction optical material comprises forming layers of Silicon Oxide.

19. The method of claim 16, wherein the forming the layer of the durable optical material comprises forming a layer of Aluminum Oxide.

20. The method of claim 16, wherein the forming the over-coating comprises forming a coating of Silicon Oxide.
